(19) United States
(12) Patent Application Publication
(10) Pub. No.: US 2010/0096068 A1
(43) Pub. Date: Apr. 22, 2010

(54) PROTECTION AND REPAIR OF STRUCTURE SURFACES WITH HAND-LAID COMPOSITE MATERIALS

(75) Inventors: Kok Seng Foo, Singapore (SG); Chin Kau Quah, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(73) Assignee: OFFSHORE TECHNOLOGY DEVELOPMENT PTE LTD, Singapore (SG)

(21) Appl. No.: 12/646,930

(22) Filed: Dec. 23, 2009

Related U.S. Application Data
(63) Continuation of application No. 11/014,821, filed on Dec. 20, 2004, now abandoned.

(30) Foreign Application Priority Data
May 25, 2004 (SG) 200402970-8

(51) Int. Cl. B29C 73/10; B32B 38/16

(52) U.S. Cl. 156/98; 156/281

(57) ABSTRACT

A method of protecting and repairing surfaces of structures using hand-laid epoxy and glass-aramid fabric composite is taught. Unlike the use of such composites as structural members, the present invention makes use of such composites in novel and inventive applications. Also unlike other methods, the invention is carefully hand-laid to conform closely to any irregular surfaces on the structure to be protected or repaired. The product of the method of the present invention is tougher than conventional paints and coatings and lasts significantly longer than conventional paints and coatings.

### RELATED APPLICATION

The present application is a continuation of U.S. Ser. No. 11/014,821 filed on Dec. 20, 2004, the disclosure of which is herein incorporated in its entirety.

### FIELD OF THE INVENTION

The present invention relates to protection and repair of structures against corrosion, weathering and chemicals.

In particular, this invention relates to methods of protecting and repairing marine structures with hand-laid composites, particularly glass-epoxy composites.

### BACKGROUND OF THE INVENTION

In the marine industry, man-made structures are usually protected by painting. Such structures include ships and other vessels, inshore structures such as port and harbor facilities, and offshore structures such as oil rigs.

However, paint, even high-quality paint, has low mechanical strength and is thus relatively brittle or “soft”, that is, it is not able to withstand knocks. Any impact with hard objects, such as tools dropping on painted surfaces, may cause the paint to chip and crack.

In addition, if the painted surface has sharp corners or is irregular, paint over these surfaces and corners are also susceptible to cracking and abrasion. When paint cracks, the underlying substrate is exposed to the elements and corrosive chemicals. This exposure will cause rust, which will in turn, compromise the integrity of the structure.

Structures in the marine industry are additionally exposed to sea or salt water which accelerates corrosion. As such, rectifying cracks in the paint of painted marine structures is more pressing than for structures not subject to salt water.

To rectify these cracks in the paint, the current methods are to first remove the compromised paint and any rust present, followed by repainting of the substrate.

The methods used to remove the old paint are determined by the severity of the rust. These include sand blasting, wire scrubbing, power and hand sanding. The degree of surface preparation in the industry is usually to meet Standard SA2-1/2 under IS08501-1:1988.

While the procedure for preparing substrate surfaces for painting is apparently simple, surface contours of the substrate may not allow proper preparation. These include welds joining different structural members where the surface is highly uneven or irregular. In addition, welded members may join at different angles. These irregular, uneven surfaces and angle corners do not permit proper preparation nor allow paint to properly adhere. As such, these are locations where rust tends to originate even when they are painted over. Improper surface preparation also does not allow an ideal surface for the paint to optimally adhere to the substrate.

As paint is not an ideal protection for marine structures, inventors have sought to provide better materials that can better protect these surfaces.

A tougher coating that is often used in the art for challenging, corrosive environments is the group of polymer resins commonly known as epoxy. The unpolymerized epoxy resin may be applied as a powder or liquid. As a powder, it is usually electrostatically sprayed on and then heated to melt and crosslink the epoxy molecules. This polymerizes or “cure” the epoxy. As a liquid, epoxy is usually mixed with a hardener to cure it.

The durability of epoxy coatings may be improved by additives. For example, RU2211231C1 by Kravtsov et al uses finely ground quartz glass powder as an additive. On the other hand, in U.S. Pat. No. 6,294,597, Rinde et al teaches the use of an inorganic filler with an epoxy resin to protect a substrate.

Another approach by Proshin et al (RU2188802C2) adds, among other ingredients, 20 mm long polyethyleneterephthalate fibers to the epoxy to enhance resistance of the protective coating. In these approaches, the additives are added to the epoxy, mixed and then the mixture is applied to the surface to be protected.

A departure from these epoxies with additives as a protective coating is that of JP62127482A2 by Hirata and Sugimoto. Here, the inventors teach the use of an elastomer formed into a “rubber” sheet and adhered to surfaces with a flexible epoxy resin to protect submarine steel structures. The elastomer rubber sheet is not mixed with the epoxy. Rather, the epoxy is only used as an adhesive.

However, even with these improvements, protection is only marginally better, especially for marine structures exposed to the elements and wave action or those with uneven surface contours. This is because the methods of the prior art do not adequately protect against “creeping” of corrosion at the interface of coating and substrate surface. Generally coating defects are caused by peeling and poor adhesion due to solvent retention, humidity, exudations, oils and greases. Cracks are easily formed due to inappropriate coatings or excessively thick layers of coating.

Therefore, a need clearly exists for methods to improve the protection of the surfaces of marine structures that is more durable than paint or epoxy alone. Generally, areas that are uneven or with irregular surfaces require better protection. In particular, enhanced protection of welds at curved or angled portions of marine structures than that afforded by methods of the current art is needed.

### SUMMARY OF THE INVENTION

The present invention seeks to provide a method for a coating to protect and repair surfaces of structures.

Accordingly, in one aspect, the present invention provides a method of protecting a welded surface of a marine structure against corrosion. The method comprising: cleaning said welded surface of rust and any loose debris; laying a fiber sheet saturated with liquid resin over said welded surface; smoothening said fiber sheet to remove any air bubbles and bunching of fibers in said fiber sheet; allowing said liquid resin to partially polymerize; laying a fiber sheet over said laid fiber sheet, wherein said fiber sheet is smaller in size than said laid fiber sheet and said fiber sheet is saturated with liquid resin, smoothening said newly laid fiber sheet and allowing said liquid resin to partially polymerize; building up a thickness of said fiber sheets and resin until it reaches substantially 1.5 mm, when said liquid resin is fully polymerized, by repeating said steps of laying a fiber sheet, smoothening and allowing the liquid resin to partially polymerize such that edges of the different layers of said fiber sheets formed a perimeter with feathered edge around said welded surface; laying a fiber sheet saturated with liquid resin over said feathered perimeter edge; and allowing said liquid resin to fully polymerize before deploying said marine structure. The fiber sheets and liquid resin composite conforms to the welded surface to provide corrosion protection to said marine structure.

In another aspect, the present invention provides a method to repair defects such as depressions in the surface of structures. The method for patching a depression in a substrate comprises preparing the inside surface of the depression; preparing the surface adjacent to the depression; applying a fiber sheet wetted with an unpolymerized liquid resin into the depression; smoothening the fiber sheet to fit into the depression; allowing the resin to polymerize partially; applying one or more other fiber sheets wetted with the unpolymerized liquid resin until the surface of the substrate; applying a fiber sheet wetted with the unpolymerized liquid resin over the filled depression; smoothening the fiber sheet to remove bubbles; allowing the resin to polymerize partially; applying one or more other fiber sheets wetted with the unpolymerized liquid resin; and allowing the resin to polymerize fully, wherein a fully-polymerized protective composite of resin and fabric that conforms to the surface of the substrate is obtained.

In yet another aspect, the present invention provides a coating to protect a substrate, wherein the coating of a composite comprises at least one layer of a fiber sheet in a polymerized resin matrix, the composite obtained by applying the at least one fiber sheet wetted with the resin in an unpolymerized liquid form over the surface of the substrate; smoothening the fiber sheet; allowing the resin to polymerize partially; adding one or more additional resin-wetted fiber sheets; and allowing the resin to polymerize fully; thereby forming a protective composite coating of resin fiber sheet on the substrate.

### BRIEF DESCRIPTION OF THE DRAWINGS

A preferred embodiment of the present invention will now be more fully described, by way of example, with reference to the drawings of which:

FIGS. 1A and 1B illustrate the cross-section of coatings of the present invention;

FIGS. 2A and 2B illustrate the present invention as applied to the corner of a structure such as a brine tank;

FIGS. 3A and 3B show how the present invention may be applied to the welded joint of two structure members; and

FIGS. 4A-4C show how areas damaged by rust may be repaired by the method of the present invention.

### DETAILED DESCRIPTION OF THE DRAWINGS

A detailed description of the present invention will now be given in accordance with a preferred embodiment of the invention. In the following description, details are provided to describe the preferred embodiment. It shall be apparent to one skilled in the art, however, that the invention may be practiced without such details. Some of these details may not be described at length so as not to obscure the invention.

There are many advantages of the present invention over the prior art. The first advantage is that minor surface defects such as uneven surfaces formed during fabrication, or pitting caused by the removal of rust, may be rectified by the method of the present invention.

Another advantage is that the coating obtained by the method of the present invention is tougher than conventional paint, can withstand accidental shocks and knocks by tools, and lasts significantly longer than either paint or epoxy alone.

Yet another advantage is that the predisposition of corner surfaces formed by welded members to rust can be protected against corrosion by the method of the present invention.

In brief, the present invention uses a resin to protect a substrate but reinforces the resin with plies or layers of a suitable fabric-like material, essentially hand applying the materials, curing it to form a tough, protective composite. The techniques used are similar to those used for hand fabricating composite structures. However, the trend for such techniques is towards manufacture of composite products such as vehicles (bicycles, ships and aircraft) and not towards the use of such composites for protection and repair of existing structures. As the direction of the art of fabricating composite items points away from the methods taught under the present invention, the present invention should be seen as inventive.

A few definitions of some terms as used in the present application will be useful. A structure is any man-made construction and marine structures are usually made of metal, particularly marine-grade steel. While the invention is directed primarily at protecting steel structures from chemical attack (corrosion), it may also be used to protect other non-metallic structures from mechanical damage.

With respect to a coating on these structures, the material of the structures is the substrate upon which the coating is deposited. In general, a composite is defined as macroscopic combination of two or more distinct materials, having a recognizable interface between them.

In the present invention, a resin, preferably epoxy resin, forms the matrix while a fabric sheet, preferably sheets comprising a network of glass fibers or a hybrid network of glass and aramid fibers, act as the “skeleton” or reinforcement for the resin matrix. Similar composites have been used in other industries such as the electrical engineering field where pre-fabricated composites of such “engineering plastics” are used for their structural, and electrical and thermal insulating properties. An example of such a product is glass-epoxy, available as rigid sheets of various thickness, similar to plywood.

In the present invention, unlike that of JP62127482A2 by Hirata and Sugimoto, the composite is not pre-fabricated and simply brushed on, but largely hand-laid as a protective coating for marine structures. It is readily apparent that manual fabrication is necessary for the coating to drape well, so as to conform to the curved surfaces, angles and corners of marine structures.

As such, other reinforcement materials such as commonly obtainable cotton, linen or paper sheets are not suitable as they do not drape well. Also, these materials absorb and retain water and are hence further unsuitable. The material must also be easily used by semi-skilled or unskilled workers and do not require special handling.

To practise the present invention, several main types of materials are needed. Any organic or inorganic sheets that drape well, have no or low water absorption, and meet the desired strength characteristics may be used. In particular, netting material—material that have a visibly coarse or open weave—drape well and are thus suitable.

Ideal candidates for reinforcement material are sheets of netting made of inorganic glass fiber or hybrid organic-inorganic materials such as glass-aramid sheets. These meet the requirements for use in the present invention and are obtained from various suppliers. While these two types of sheets are used as examples, netting sheets made of other suitable materials such as carbon fiber or closely woven sheets of “microfiber” nylon, polyester or rayon that drape well may also be used and come under the scope and spirit of the present invention.

A fabric using aramid fibers in the warp orientation and glass fibers in the weft orientation is used in the preferred embodiment of the present invention. This fabric, when dry, has a tensile strength of 470,000 psi, a tensile modulus of 10,500,000 psi and a maximum elongation of 4.5%. Its thickness is 0.014 inches and it has a density of 0.092 lbs per cubic inch.

The preferred matrix material is epoxy resin in a liquid form, obtainable from various suppliers. However, other suitable resins may also be used to practise the invention. There are many types of epoxies and suitable examples are those that are moisture resistant, have low cure shrinkage and sufficient flexibility and toughness to resist commonly-encountered knocks from workers working around the structures. Also usable are epoxies that have thermoplastic or rubber additives pre-mixed in them.

After testing various epoxies, the present invention uses bi-component epoxy comprising a Component A of the epoxy is mixed in the manufacturer's suggested ratio of 100:42 by volume with Component B. This may be done by mechanically-stirring the mixture in the suggested ratio in a low-speed mixer at 400-600 rpm for five minutes. The mixture thus prepared is curable at ambient temperature. Specifically, this mixture cures in 72 hours (or 3 days) at 15° C. A catalytic accelerator may be used to speed up the curing process if desired. When fully cured, the epoxy has a tensile strength of 10,500 psi, a tensile modulus of 461,000 psi and a maximum elongation of 5%.

To bond the organic matrix with the inorganic reinforcement, a hydrophobic silane coupling agent is also required. The silane coupling agent enhances bonding between the fiber sheet, epoxy and the structure to be coated and is usually added in the ratio of 0.1%-1.0% by weight as recommended by the manufacturer. After the silane coupling agent is added to the epoxy mixture, it is further stirred for a few more minutes to ensure that the mixture is homogenous.

The present invention teaches several methods to protect marine structures using the fabric and pre-mixed epoxy mixture described above. These methods share some common steps and additions or departures from these common steps for specific situations will be highlighted.

The main common steps apply to a large even surface, like that for a steel plate. This may be done by light sandblasting or grinding, followed by cleaning with a brush or air jet to remove any debris. The methods of the present invention render unnecessary any protracted sandblasting or cleaning as needed for painting.

A piece of the reinforcing aramid-glass fiber sheet is then measured and cut. The size and shape of the sheet is predetermined to overlap the spot to be covered by five to 10 times in the two linear dimensions.

The fiber sheet is then wetted, preferably saturated, with the prepared bi-component epoxy mixed and silane coupling agent and laid over the spot to be covered. Saturation of the fiber sheet may be done by immersing it in a tank of mixed unpolymerized epoxy and silane coupling agent.

A roller brush dampened with the epoxy mixture is then used to remove air bubbles in the fiber sheet and smoothen any “bunching” of the material. During application of the fiber sheet, it is important not to stretch or distort the fabric, otherwise voids may be formed in the matrix after the epoxy has cured. Additional epoxy may be applied by brushing or spraying if desired, or to smoothen out uneven patches.

Before the matrix has fully cured, a second fabric sheet of similar shape but smaller than the first sheet is similarly wetted or saturated with the epoxy mixture and laid over the first sheet. The degree of curing is to allow the earlier sheets to remain adhered to the substrate and not be shifted by the application of the subsequent sheets. The degree of curing is not a full, complete cure so as to allow proper bonding of the epoxy of the laid sheet with that of the subsequent sheets.

For additional strength, the orientation of the second sheet is preferably laid at an angle (say 45 degrees to the first sheet). However, this may not always be needed. The second fabric sheet is then similarly smoothened to remove air bubbles and bunching of the fabric. Additional epoxy may be applied by brushing or spraying if desired, or to smoothen out uneven patches.

Alternatively, a fabric with diagonal directionality, that is, the fibers are not arranged in the conventional perpendicular weft and warp orientations but are diagonal to each other, may be used. With such a fabric, the need to change the orientation of the fabric for each subsequent fabric layer is obviated.

This process is repeated until a suitable thickness of fabric and epoxy is built-up. For protection of most structures, a cured composite thickness of 1.5 mm will provide sufficient protection for the substrate under most environmental conditions. Severe environmental conditions may dictate a thicker coating as appropriate.

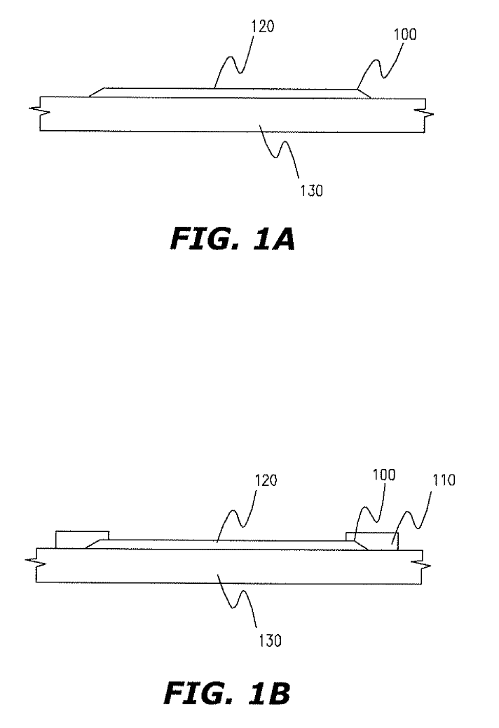

In general, each subsequent layer of the fabric sheet is similar in shape but smaller in area to the layer already laid. This is to_create a “feathered” edge 100 so as not to present an abrupt edge that encourages peeling of coating (FIG. 1A). For additional protection against peeling, another perimeter 110 of composite may be similarly built up around the edge of the first coating against peeling (FIG. 1B). A coating without the feathered edges or the perimeter, while not as durable as one with these features, remains under the scope of the present invention.

Once fully cured, this hand-laid coating will form a protective composite of aramid glass epoxy 120 over the substrate 130. The inventors have found that the composite of the present invention has a maximum tensile strength in the warp direction of 66,720 psi and maximum elongation of 5.0%.

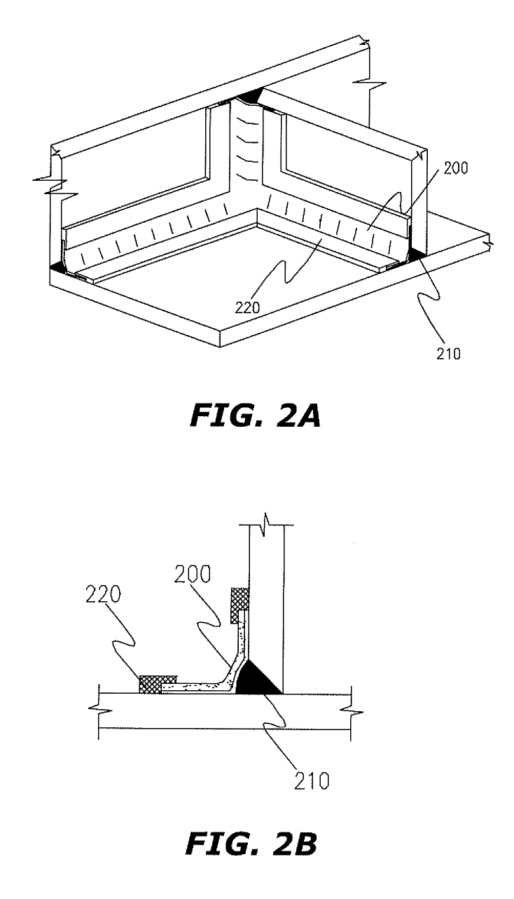

FIGS. 2A and 2B show the elevational view and cross-section, respectively, of the method of the present invention applied to the corner of a structure such as a brine tank. These two figures show the composite coating 200 laid over the weld 210 of metal plates. The composite coating is further enhanced and its edges reinforced by a perimeter coating 220 of epoxy alone, or the same aramid glass epoxy composite.

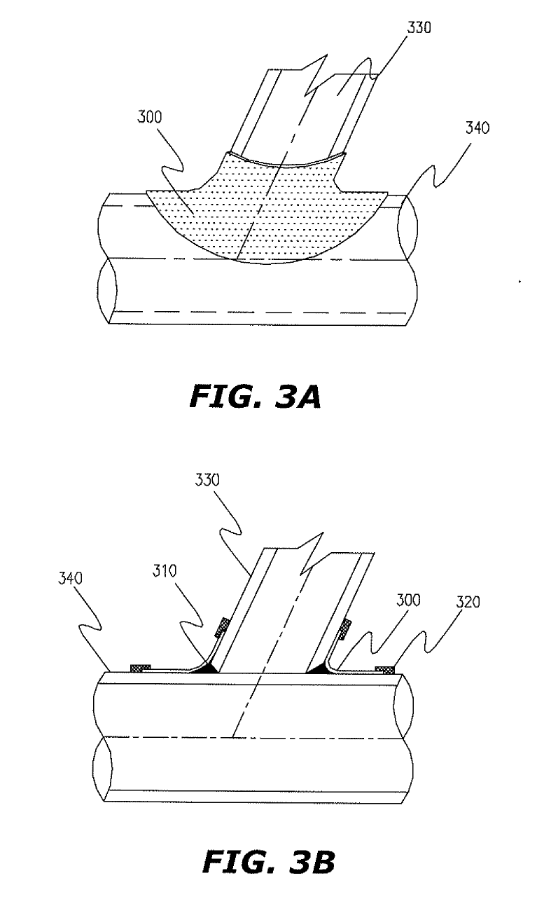

FIGS. 3A and 3B show the elevation view and cross-section of a welded joint of two structural members 330, 340 at an angle to each other. To achieve the composite coating 300, strips of epoxy-saturated fabric material are evenly wrapped around the weld 310. Reinforcing perimeters 320 of the same composition may be also be added if desired.

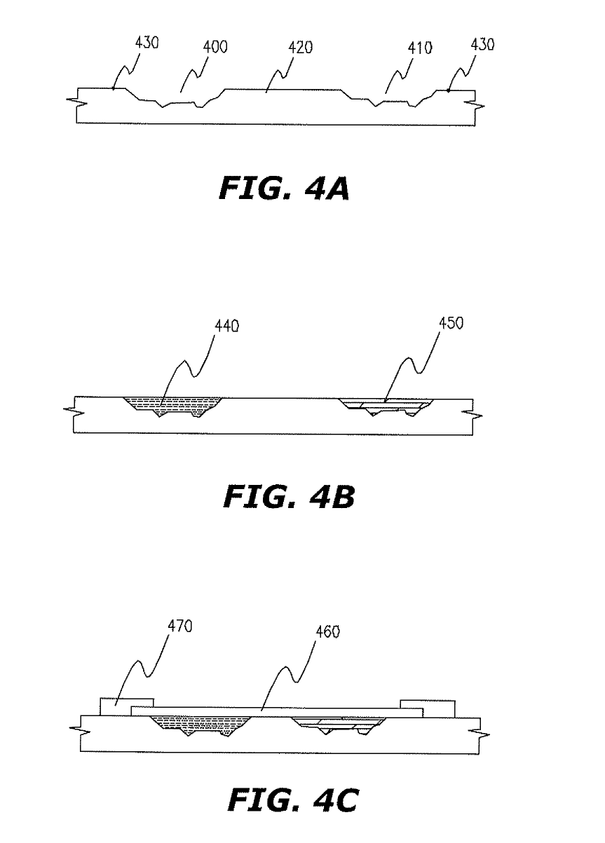

The present invention may also be used to repair pitting in corroded plates. For this, the damaged areas (FIG. 4A 400, 410) of the substrate 420 are removed by conventional methods such as chipping and sanding. Rust, previous coatings and other debris are then removed from the damaged area, particularly from the inside surface walls of the depression. A suitable area 430 bordering the depression or damaged area is also prepared. Thereafter, the depression of the damaged substrate may then be filled 440 by conventional methods (FIG. 48). These include patching the eroded spots with a mixture of epoxy and suitable fillers 440, well-known in the industry, to form a smooth even surface.

Alternatively, small swatches of the epoxy-saturated fabric 450 may be used to patch and fill these spots, building up to the surface of the structure in a similar manner as taught above. Thereafter, the earlier steps of the method of the present invention directing to building up of layers of the composite 460 may then be used to protect the damaged area.

The rationale for clearing the substrate surface 430 bordering the damaged spots is to allow for the method of the present invention to coat the damaged area as described above (FIG. 4B). Shown in FIG. 4B are the corroded areas patched and coated by the method of the present invention without any reinforcing parameters. Alternatively, reinforcing parameters 470, as taught by the method of the present invention, may be fabricated. Tests by the inventors have shown that damage as severe as extending to 25% of the thickness of the substrate for non-load bearing structures may be repaired by the method of the present invention. This saves costs as it obviates replacing the damaged parts of the substrate.

There are several advantages of the method of the present invention. The composite coating provides a tough and durable protective layer for surfaces. It conforms well to irregular and angled surfaces and joints as it is hand-laid. The coating may be built up as thick as desired or suitable for the surface to be protected. The coating of the present invention may also be used to repair minor defects in the surface to be protected.

The present invention therefore provides a main method and several secondary methods of coating and protecting structures from corrosion and weathering. In another aspect, the present invention also claims the protective coatings as taught on structures to be protected.

It will be apparent to one skilled in the art that the present invention is novel and inventive over the methods of the prior art as the coating thus fabricated is tougher and more durable than coatings that are merely painted or sprayed on.

The teachings of the present invention overcome, or at least alleviate, the problem of the prior art. It will be appreciated that although only a few preferred methods has been described in detail, various modifications and improvements can be made by a person skilled in the art without departing from the scope of the present invention.

What is claimed is:

1. A method of protecting a welded surface of a marine structure against corrosion, the method comprising:
cleaning said welded surface of rust and any loose debris;
laying a fiber sheet saturated with liquid resin over said welded surface;
smoothening said fiber sheet to remove any air bubbles and bunching of fibers in said fiber sheet;
allowing said liquid resin to partially polymerize;
laying a fiber sheet over said laid fiber sheet, wherein said fiber sheet is smaller in size than said laid fiber sheet and said fiber sheet is saturated with liquid resin, smoothening said newly laid fiber sheet and allowing said liquid resin to partially polymerize;
building up a thickness of said fiber sheets and resin until it reaches substantially 1.5 mm, when said liquid resin is fully polymerized, by repeating said steps of laying a fiber sheet, smoothening and allowing the liquid resin to partially polymerize such that edges of the different layers of said fiber sheets formed a perimeter with feathered edge around said welded surface;
laying a fiber sheet saturated with liquid resin over said feathered perimeter edge; and
allowing said liquid resin to fully polymerize before deploying said marine structure;
wherein the fiber sheets and liquid resin composite conforms to the welded surface to provide corrosion protection to said marine structure.

2. A method according to claim 1, wherein said fiber sheets overlap said welded surface by about 5 to 10 times the dimensions of the welded surface.

3. A method according to claim 1, wherein said liquid resin comprises a two-components epoxy mixed in a ratio of 100:42 by volume, which polymerizes after 3 days at about 15° C. to give a tensile strength of about 10,500 psi, a tensile modulus of 461,000 psi and elongation of about 5%.

4. A method according to claim 1, wherein said fiber sheets comprise glass fibers.

5. A method according to claim 1, wherein said fiber sheets comprise glass and aramid fibers to give said composite a tensile strength of about 66,700 psi.

6. A method according to claim 1, wherein said fiber sheets comprise fibers selected from the following: carbon, nylon, polyester and rayon.

7. A method according to claim 6, wherein said fiber sheets further comprise glass fibers.

8. A method according to claim 1, wherein said smoothening step is performed with a roller brush.

9. A method according to claim 1, wherein fibers in adjacent layers of said fiber sheets are oriented at an angle to each other.

10. A method according to claim 1, wherein fibers in each said fiber sheets are oriented orthogonally in warp and weft directions.

11. A method according to claim 1, wherein fibers in each said fiber sheets are oriented in diagonal directions.

12. A method according to claim 1, wherein the liquid resin further comprises a silane coupling agent, which is in the ratio of about 0.1% to about 1% by weight.

13. A method according to claim 1, wherein said marine structure is newly built.

14. A method according to claim 1, wherein said marine structure is repaired or refurbished.
